(19) United States
(12) Patent Application Publication
(10) Pub. No.: US 2006/0240831 A1
(43) Pub. Date: Oct. 26, 2006

(54) Method, apparatus and computer program providing high-speed downlink packet access (HSDPA) cell change without RRC acknowledgment

(75) Inventors: Antti Toskala, Espoo (FI); Matti Jokimies, Salo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/412,194

(22) Filed: Apr. 25, 2006

Related U.S. Application Data
(60) Provisional application No. 60/674,984, filed on Apr. 25, 2005.

(51) Int. Cl. H04Q 7/20

(52) U.S. Cl. 455/436

(57) ABSTRACT

Handing over a mobile terminal MT from a serving base station BS to a target BS employs a handover window HW during which the MT monitors a shared control channel of the target BS. The network determines whether to handover based on a MT measurement report. Once handover is determined, the serving BS sends over its shared data channel to the MT information about the target BS's shared control channel and a HW during which to monitor. The serving BS restricts transmissions to the MT to avoid the HW, which recurs in fixed intervals. The MT monitors the target BS's control channel during HWs, and the target BS sends the MT its identification in an HW, followed by data for the MT on the target BS's shared data channel. A handover confirmation message is then sent by the MT to the target BS, or by the target BS to an RNC.

### CROSS REFERENCE TO RELATED APPLICATION

This application claims priority to U.S. Provisional Patent Application No. 60/674,984, filed on Apr. 25, 2005, the content of which is hereby incorporated by reference.

### TECHNICAL FIELD OF THE INVENTION

The examples of this invention relate generally to digital cellular communications systems, methods, terminals and computer programs and, more specifically, relate to packet data transmission techniques for handing over a terminal from a currently serving cell to a next serving cell.

### BACKGROUND

The following abbreviations are defined as follows:

3GPP Third Generation Partnership Project

ARQ Automatic Repeat Request

BTS Base Transceiver Station

DL Downlink

DPCH Dedicated Physical Channel

F-DPCH Fractional Dedicated Physical Channel

H-ARQ Hybrid ARQ

HSDPA High-Speed Downlink Packet Access

HS-DPCCH High-Speed Dedicated Physical Control Channel

HS-DSCH High-Speed Downlink Shared Channel

HS-PDSCH High-Speed Physical Downlink Shared Channel

HS-SCCH High-Speed Shared Control Channel

MAC Medium Access Control

RLC Radio Link Control

RNC Radio Network Controller

RRC Radio Resource Control

SRB Signaling Radio Bearer

TTI Transmission Time Interval

UE User Equipment

UL Uplink

UMTS Universal Mobile Telecommunications System C304

UTRA-FDD UMTS Terrestrial Radio Access-Frequency Division Duplex

UTRAN UMTS Terrestrial Radio Access Network

VoIP Voice Over Internet Protocol

WCDMA Wideband Code Division Multiple Access

The DL packet data transmission in UTRA-FDD (WCDMA) is a feature included in Release 5 specifications (HSDPA) and is further enhanced in Release 6 with the support of fractional DPCH (F-DPCH) and with the support of SRB mapping on the HS-DSCH.

Currently there is development work proceeding for Release 7. One HSDPA improvement that is of concern is to increase the speed of the handover process with HSDPA, particularly for real time applications such as VoIP.

A problem is created where a mobile terminal needs to change (handover) a serving HS-DSCH cell (within the active set) before obtaining a related RRC Signaling acknowledgment, when the handover is based on the terminal signaling towards the network. In such a case the terminal does not have certainty that the handover has taken place, and thus has to receive (listen to) the HS-SCCH(s) from two cells.

One proposal related to this problem has been presented in RI-050324 (3GPP TSG-RAN1 Meeting #40bis, Apr. 4-8, 2005, Beijing, China, Lucent Technologies), where it is suggested that the terminal listen for some period of time for two HS-SCCHs from two different cells. However, this approach would result in additional complexity from the terminal receiver point of view, and may require a change to the terminal receiver structure.

### SUMMARY

The foregoing and other problems are overcome, and other advantages are realized, in accordance with the herein described embodiments of these teachings.

In accordance with one embodiment of the invention is a wireless communication system that includes a serving cell and a target cell for handing over a mobile terminal. The serving cell comprises a processor, a memory for storing a first set of instructions, a transceiver and an antenna, which together are is configured to wirelessly send a message to the mobile terminal that includes information needed to receive a shared control channel of the target cell. The target cell comprises a processor, a memory for storing a second set of instructions, a transceiver and an antenna, which together are configured to schedule a data packet for transmission to the mobile terminal, to wirelessly send an identification of the mobile terminal over the shared control channel at a time defined by the information, and to wirelessly send the data packet to the mobile terminal over a shared data channel.

In accordance with one embodiment of the invention is a method that includes receiving, over a first shared channel from a serving base transceiver station, channel information about a second shared channel of a target base transceiver station and a handover window. Further, the received channel information is then used to monitor the second shared channel during the handover window of each of at least two fixed time intervals.

In accordance with another embodiment of the invention is a mobile terminal that includes an antenna, a transceiver coupled to the antenna, a processor coupled to the transceiver, and a memory coupled to the processor for storing a set of instructions that are executable by the processor. The executed instructions determine from a first message, received at the transceiver over a first channel, a second channel to monitor and a handover window during which to monitor. The instructions are further for tuning the transceiver to monitor the second channel during the handover window of each of at least two fixed time intervals.

In accordance with another embodiment of the invention is a program of machine-readable instructions, tangibly embodied on an information bearing medium and executable by a digital data processor, to perform actions directed toward handing over a mobile terminal between network elements. The actions include determining channel information about a second shared channel of a target base transceiver station and a handover window from a message, where the message is wirelessly received over a first shared channel from a serving base transceiver station. The actions further include configuring a transceiver to monitor the second shared channel during the handover window of each of at least two fixed time intervals, using the received channel information.

In accordance with another embodiment of the invention is a method that includes transmitting, from a serving base transceiver station to a mobile terminal over a first shared channel, channel information about a second shared channel of a target base transceiver station and a handover window. Further in the method, all transmissions from the serving base transceiver station to the mobile terminal are then restricted, subsequent to the transmitting, so as to avoid the handover window within each of at least two fixed time intervals.

In accordance with another embodiment of the invention is a network element that includes an antenna, a transceiver coupled to the antenna, a processor coupled to the transceiver, and a memory coupled to the processor for storing a set of instructions that are executable by the processor. The executed instructions compile a first message that includes information about a second channel and a handover window during which to monitor the second channel. The executed instructions further configure the transceiver to send the first message over a first channel to a mobile terminal, and restrict transmissions from the network element to the mobile terminal so as to avoid the handover window of each of at least two fixed intervals subsequent to sending the first message.

In accordance with another embodiment of the invention is a program of machine-readable instructions, tangibly embodied on an information bearing medium and executable by a digital data processor, to perform actions directed toward handing over a mobile terminal between network elements. These actions include transmitting, from a serving base transceiver station to a mobile terminal over a first shared channel, channel information about a second shared channel of a target base transceiver station and a handover window. Further, the actions include restricting all transmissions from the serving base transceiver station to the mobile terminal so as to avoid the handover window of at least two fixed time intervals subsequent to the transmitting.

In accordance with another embodiment of the invention is a method for operating a network element. In this method, a transmission directed to an individual mobile terminal that is not under the control of a network element sending the transmission is sent over a shared control channel and during a predefined handover window. Following sending that transmission over the shared control channel, the method includes sending a transmission directed to the individual mobile terminal over a shared data channel. Then, it is confirmed that communication with the mobile terminal over the shared data channel is established. Responsive to that confirming, a handover confirmation message is sent to a radio network controller.

In accordance with another embodiment of the invention is a method for downlink packet data transmission within UTRAN using HSDPA. In the method, a terminal initiates a measurement report in the uplink direction that indicates a change of best serving cell for high-speed data packet access HSDPA, the change being from a serving cell to a target cell. The terminal listens, during a predefined time instant, to a high speed shared control channel HS-SCCH of the target cell. The predefined time instant is relative to the measurement report sent in the uplink direction. Relative to the measurement report may be determined by the RNC based on the time the measurement report was sent, an offset from a transmission window in which the measurement report was sent, or a predefined elapsed time (and possibly also a predefined window interval) from a sending time of the measurement report, to name a few examples. In this method, the terminal does not need to listen to a HS-SCCH of both the serving cell and of the target cell at any given time during the change to the target cell. Note that in embodiments wherein the serving cell and/or the target cell operate more than one HS-SCCH, the terminal may monitor more than one HS-SCCH of a single cell, but to effect the change from the serving cell to the target cell, the terminal need not simultaneously monitor a HS-SCCH from both the serving cell and the target cell.

Below the invention is described in further detail and with various implementation options.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a simplified block diagram showing the major elements used to implement this invention;

FIG. 2 is a timing/waveform diagram (not to scale) that is descriptive of the occurrence of events in the time domain; and

FIG. 3 is a signaling flow diagram between the network elements shown in FIG. 1 and UTRAN elements.

FIG. 4 is a process diagram showing steps used in implementing an embodiment of the invention.

### DETAILED DESCRIPTION

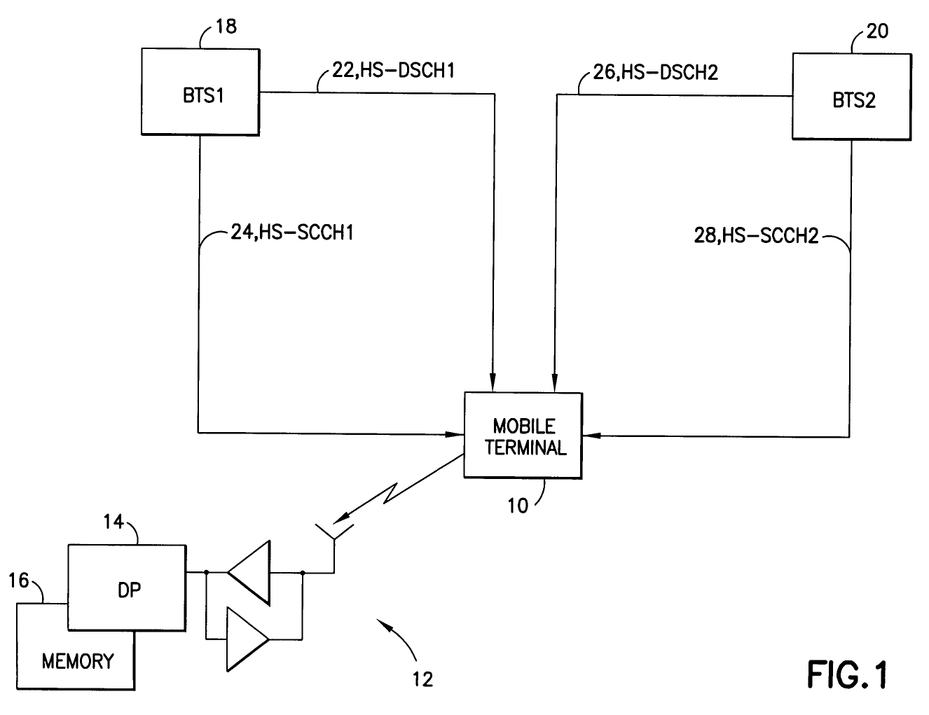

FIG. 1 is a simplified block diagram showing the major elements used to implement this invention, specifically a HSDPA terminal 10, also referred to as User Equipment or a mobile terminal 10, a first (currently serving) BTS (BTS1) 18 and a second (target) BTS (BTS2) 20. The serving BTS 18 is assumed capable of transmitting over a DL HS-DSCH1 22 and a HS-SCCH1 24 to the terminal 10, and the target BTS 20 is assumed capable of transmitting a DL HS-DSCH2 26 and HS-SCCH2 28 to the terminal 10. The channels HS-DSCH1 and HS-DSCH2 are termed more generally herein as (downlink) shared data channels 22, 26 of the respective serving 18 and target 20 BTSs, while the channels HS-SCCH1 and HS-SCCH2 are termed more generally herein as (downlink) shared control channels 24, 28 of the respective serving 18 and target 20 BTSs. As used herein, but not as a limitation on the practice of this invention, the serving 18 and target 20 BTSs are each assumed to be functionally equivalent to a Node B network entity as described in various 3GPP 25-series specifications. Also whether the handover is inter-cell or intra-cell is not relevant to this invention. In general, handover is assumed to refer to the HSDPA terminal 10 cell change, where the terminal 10 changes its reception of traffic from the serving to the target cell (BTS).

FIG. 1 shows that the mobile terminal 10 includes a suitable wireless transceiver 12 coupled to a data processor (DP) 14 that in turn includes or is coupled to a volatile and/or non-volatile memory 16. The memory 16 stores program code that is executable by the DP 14 to operate with the serving BTS 18 and target BTS 20, including program code that is provided to implement the HSDPA terminal 10 aspects of this invention.

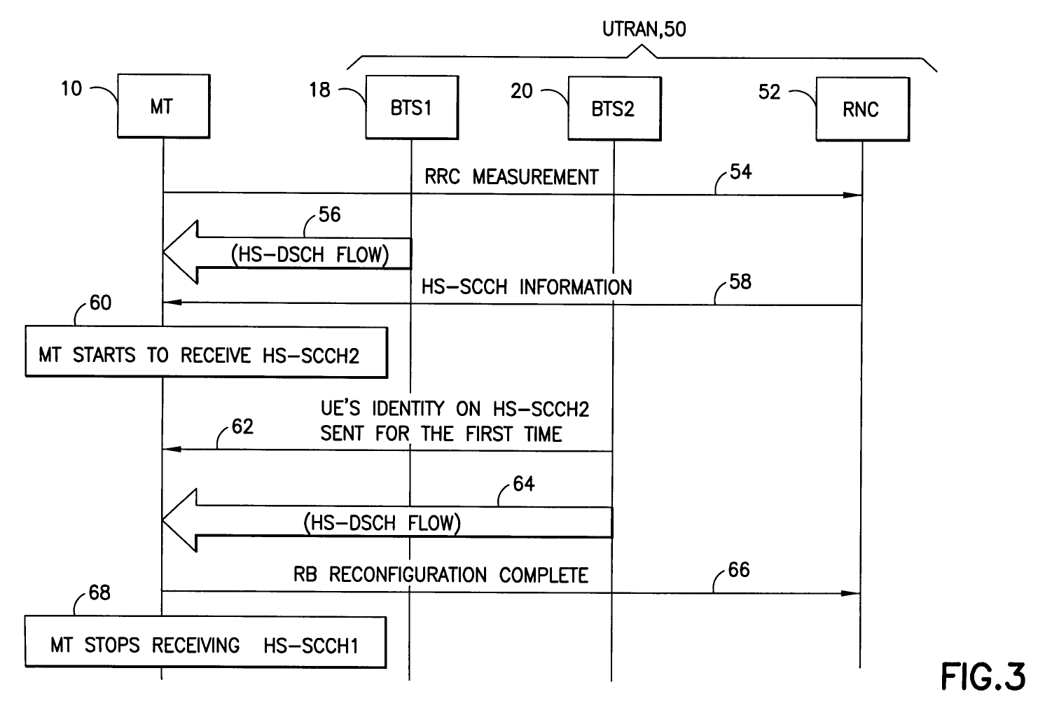

Although not shown, it will be appreciated that each BTS 18, 20 will be similarly constructed, and a corresponding memory stores program code that is provided to implement the BTS aspects of this invention in conjunction with a corresponding BTS DP. The RNC 52 (see FIG. 3) will also include a DP and a memory that stores program code that is executable by the RNC DP to operate with the serving BTS 18 and target BTS 20, as well as the HSDPA terminal 10, in order to implement the RNC-aspects of this invention.

It is noted that the role of the RNC 52 (see FIG. 3) is not considered in FIG. 1 or in the text related to that Figure. However, in practice some messages may originate from or terminate in the RNC 52, even though the serving BTS 18 and the target BTS 20 may relay such messages (e.g., see FIG. 3). The RNC 52, the serving BTS 18, and the target BTS 20 may each be referred to for convenience as network elements, and collectively as the network 50. The mobile terminal 10 does not form a part of the network 50 but rather uses the network 50 to facilitate communications with other user equipment.

In accordance with the teachings of this invention the mobile terminal 10 is enabled to perform a change of serving HS-DSCH cell (for the cells within the active set) without having to listen to more than a single shared control channel at a time. This is accomplished in one embodiment by defining a period of time, also referred to as a handover window, following the transmission of measurement information from the mobile terminal 10, during which the target network node 20 should send a packet to the mobile terminal 10 (or a dummy packet in the case there is no data to be transmitted) over the shared data channel 26 of the target network node 20. The serving BTS 18 is not to transmit over its shared control channel 24 to the mobile terminal 10 during that handover window, thereby allowing the mobile terminal 10 an opportunity to receive from the target network node 20 over its shared control channel 28, without risk of missing a transmission from the serving network node 18.

In one non-limiting embodiment the mobile terminal 10 sends the measurement information to the network 50 (e.g., UTRAN, which includes the RNC 52 and the serving 18 and target 20 BTSs, see FIG. 3) when the measurement reporting is triggered for the change of best serving HS-DSCH cell measurement report. The measurement report may be the HS-DSCH cell measurement report. The report is preferably sent in MAC or RRC layer signaling to the BTS/RNC. The network 50 makes the decision whether to handover or to not handover the mobile terminal 10. For the case where the handover of the mobile terminal 10 is to take place, a “HS-SCCH INFORMATION” message that is descriptive of the shared control channel 28 of the target network node 20 is sent to the mobile terminal 10.

As employed herein, the “HS-SCCH INFORMATION” message denotes a newly defined RRC message used to carry information concerning at least one shared control channel of at least one neighboring (non-serving) base station/network node [including any time offsets relative to the serving node's timing] and the time intervals when the mobile terminal 10 is to receive that information. In practice, the HS-SCCH INFORMATION message may be implemented by modifications to the Radio Bearer Reconfiguration message as already defined in 3GPP TS 25.331. The current Radio Bearer Reconfiguration message contains a “HS-SCCH Info” Information Element, which includes the HS-SCCH parameters (e.g., channelization codes of the HS-SCCH channels to be received). The existing “HS-SCCH Info” could be amended by these teachings to include the handover window when the shared control channel 28 of the target BTS 20 is to be received by the mobile station 10. In other words, the HS-SCCH INFORMATION message could be implemented as a Radio Bearer Reconfiguration message, with modifications in the HS-SCCH Info part of that message as compared to current practice.

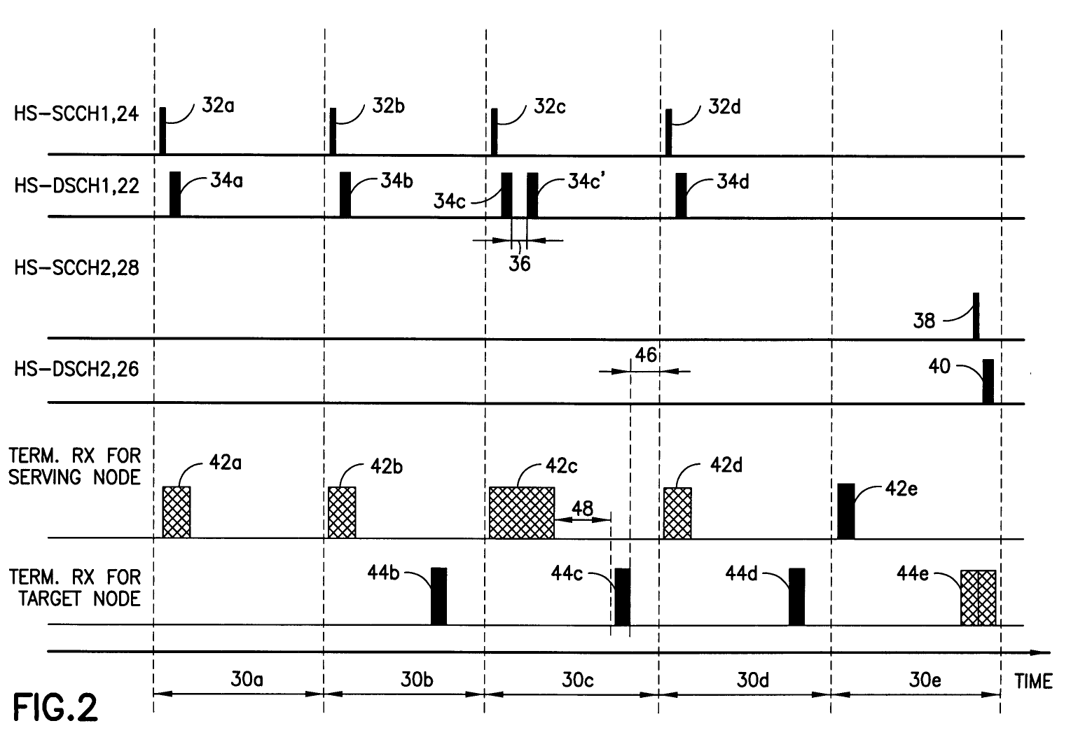

FIG. 2 details one implementation of the invention, a timing diagram illustrating various windows and messages sent by the serving BTS 18 and by the target BTS 20 to the mobile terminal 10, over the various shared data channels 22, 26 and shared control channels 24, 28. Recall from FIG. 1 that the serving 18 and target 20 BTSs do not share any of the downlink channels described herein; the “sharing” referred to relates to sharing among various mobile terminals or other user equipment. FIG. 2 is in the context of a single mobile terminal 10, and while FIG. 2 is not to scale as to the time span of a message or between messages, the relative disposition of messages is accurate for the embodiment described in FIG. 2. To avoid confusion among terms, the timing diagram is divided into five intervals 30a-30e of identical length, preferably fixed by the RNC 52 (see FIG. 3), which are related to but distinct from the time windows described below during which certain transmissions are made or expected to occur.

The following (non-limiting) assumptions are made with regard to FIG. 2. First, a fixed time allocation is in use where the mobile terminal 10 regularly receives a transmission from the serving BTS 18 over the shared control channel 24 once per N milliseconds. In FIG. 2, that fixed time allocation is the interval 30a-e, and is fixed by the network 50 (e.g., BTS or RNC). Preferably, the interval spans at least 40 milliseconds. In a typical case of an adaptive multi-rate (AMR) speech codec for conversational traffic, this equals up to two VoIP packets (header compressed RTP/UDP/IP packets) that are included in one TTI, with no significant increase in delay (e.g., about 20 ms per VoIP packet). In practice, a longer delay, such as three packets per TTI (60 ms interval) or even four packets per TTI (80 ms interval) may be feasible for meeting other (capacity) reasons, which would tend to facilitate the handover process. Second, FIG. 2 illustrates the instance where one retransmission is sufficient, although more may be needed, especially if the SRB is sent over the serving BTS's shared data channel 22. Also assumed in FIG. 2 is that the serving BTS 18 informs the mobile terminal 10, over the serving BTS's shared data channel 22, of the time period (termed herein as the handover window) in which the shared control channel 28 of the target BTS 20 must be received. Further, FIG. 2 assumes that the time difference between the serving 18 and the target 20 BTSs is known by the network 50 (preferably by the RNC 52), such as from information obtained from mobile terminal 10 measurement reports.

In a first interval 30a, the serving BTS 18 transmits a control message 32a over its shared control channel 24 to the mobile terminal 10, and then transmits a data message 34a over its shared data channel 22 to the mobile terminal. Typically, a data message 32a over a shared channel for a particular mobile terminal only follows a control message 32a for that same mobile terminal sent within that same interval 30a, as the control message 32a informs the mobile terminal 10 of the pending data message scheduled for that interval 30a. The mobile terminal 10 receives transmissions over those channels 24, 22 during a serving node monitoring window 42a of the interval 30a. The monitoring window may extend to the end of the interval 30a, but in some instances the mobile terminal 10 need only monitor the shared control channel 24 of its serving BTS 18 for a more limited period, and tuning to the shared data channel 22 only after a control message 32a is received.

At some time during the first interval 30a (not illustrated in FIG. 2), the mobile terminal transmits over an uplink channel (data or control) the measurement information it collects concerning BTSs in its active set, or at least for concerning the serving 18 and target 20 BTS. The measurement information is known in the art, and may be sent upon request of the network 50 or unilaterally by the mobile terminal 10 upon meeting one or more measured conditions (e.g., signal strength, error rate, speed, or otherwise defined thresholds). The network 50, preferably the RNC 52, uses the measurement information to determine that a handover of the mobile terminal 10 is to take place from the serving BTS 18 to the target BTS 20. Preferably, the RNC 52 determines from the target BTS 20 a handover window, and communicates it to the serving BTS 18 with instructions to begin handover procedures as below.

According to an embodiment of the invention, the serving BTS 18 transmits to the mobile terminal 10 channel information for a shared control channel of the target BTS 20 (e.g., the “HS-SCCH INFORMATION” for the target BTS's shared control channel 28) along with the handover window 44b-e (e.g., information as to when the handover window is to occur, relative to an interval 30a-e), during the data window 34b of the second interval 30b in FIG. 2. In one embodiment, that information and handover window is sent over the serving BTS's shared data channel 22, during the data window 34b of the second interval 30b immediately following (but not necessarily immediately after) the first interval 30a in which the mobile terminal 10 sent the measurement information.

The mobile terminal 10 then uses that channel information received from the serving BTS 18 to determine what channel to monitor, and monitors it during the handover window 44b-e. The handover windows 44b-e in each interval are all of the same span since they are monitored based on the single message from the serving BTS 18, and preferably the handover window 44 is defined relative to a start or end time of intervals. During the second interval 30b as shown in FIG. 2, there is no transmission to the mobile terminal 10 from the target BTS 20 over either its shared control channel 28 or its shared data channel 26. Note that in FIG. 2, for all intervals 30b-e following reception of the channel information and handover window from the serving BTS 18, and also including the interval 30b in which that channel information and handover window were received, the mobile terminal 10 monitors shared control and data channels from both the serving BTS 18 and the target BTS 20, though at no time does the mobile terminal 10 monitor both shared control channels 24, 28. This avoids the need for two network receivers for control channel purposes. More than one receiver may be used to simultaneously monitor a data and a control channel, though the timing regimen of FIG. 2 eliminates the need for more than one network receiver altogether.

The third interval 30c of FIG. 2 illustrates an embodiment wherein the timing of messages and windows is adapted to enable one or more re-transmissions over the serving BTS's shared data channel 22 in the event the mobile terminal 10 fails to receive the channel information and handover window in the data message. The data message 34c is re-transmitted 34c′ within an expanded monitoring window 42c after an interim period 36, preferably about 14 milliseconds within which the serving BTS 18 failed to receive a confirmation from the mobile terminal 10, or preferably received an automatic repeat request (ARQ) from that terminal 10. No matter how large, the monitoring window 42a-e must terminate with sufficient time 48 before the start of the handover window 44c to allow the mobile terminal 10 to re-tune to the shared control channel 28 of the target BTS 20. It also follows that the handover window 44c must terminate with sufficient time 46 before the start of the next monitoring window 42d, to allow the mobile terminal 10 to re-tune to the shared control channel 24 of the serving BTS 18. In other embodiments where the mobile terminal 10 uses different transceivers for data and control channels, only the time 46 may be of concern.

The fourth interval 30d of FIG. 2 again shows a control message 32d and data 34d from the serving BTS 18 over the relevant channels 24, 22 to the mobile terminal 10, and no message from the target BTS 20 for that same mobile terminal 10. The serving BTS 10 is still serving the mobile terminal 10, as handover has not yet occurred. While the mobile terminal 10 is properly monitoring the target BTS shared control channel 28 during the appropriate handover window 44d, there is no indication that the target BTS 20 is able to accept the mobile terminal 10 at that time. Absent some confirmation from the target BTS 20, it is preferable to leave the mobile terminal 10 under control of the serving BTS 18, to avoid ‘losing’ the mobile terminal 10 from the network if, for example, the frequency of the shared control channel 28 of the target BTS 20 or the handover window 44 was improperly encoded or decoded by the serving BTS 18 or terminal 10 without being discovered as error.

The fifth interval of FIG. 2 is where handover is effected to the target BTS 20. There happen to be no messages from the serving BTS 18, and the terminal 10 receives nothing during its serving node monitoring window 42e. Later within that same interval 30e, the mobile terminal 10 monitors the shared control channel 28 of the target BTS 20 during the handover window 44e, and receives a control message 38 indicating that there will be a data message 40 for it on the shared data channel 26 of the target BTS 20, within that same interval 30e. The control message 38 preferably includes the mobile terminal's own identity, which is its indication to monitor the shared data channel 26 of the target BTS 20 in that interval 30e. The frequency of the shared data channel may be sent to the mobile terminal 10 in the data message 34b that also carried the frequency of the shared control channel 28 of the target BTS 20, or in the first control message 38 sent from the target BTS 20 to the mobile terminal 20.

While the term frequency is used above, it is understood that the various channels 22, 24, 26, 28 may not be defined only by frequency but are preferably defined by a spreading code of time/frequency slots with messages in packet form, so the channel information described above may be a frequency, a spreading code, some indicator of the appropriate spreading code for which the mobile terminal looks up in a memory 16, or any other form of information that enables the mobile terminal 10 to tune to the channel, however that channel may be defined.

Upon the first reception by the mobile terminal 10 of a control message 38 directed toward that specific mobile terminal 10 (e.g., its own identity via a HSDPA terminal-specific CRC) on the shared control channel 28 of the target BTS 20, the mobile terminal 10 considers the handover to be completed, and sends a confirmation message while continuing reception of the data message 40 from the target BTS 20, which at that time becomes the new serving BTS (BTS2 of FIG. 1). The network considers the handover completed upon reception of that confirmation message from the mobile terminal 10.

In the case of the handover not taking place, after the HS-SCCH INFORMATION message has been sent by the network 50, the mobile terminal 10 continues to receive the existing serving BTS 18, and the mobile terminal 10 discontinues monitoring the shared control channel 28 of the target BTS 20 in response to the network sending (on whatever channel and during whatever window the mobile terminal can be reached) a message canceling the handover. This could be done, e.g., by another “HS-SCCH INFORMATION” message over the control channel 24 of the serving BTS 18, which contains null HS-SCCH information. Additionally or alternatively, the mobile terminal 10 may also suspend its monitoring of the shared control channel 28 of the target BTS 20 if it has not succeeded to decode anything on that shared control channel 28 over a pre-defined time period (e.g., 1 second).

In the case of a handover that was intended to take place, but for some reason does not occur (e.g., the shared control channel signaling is not correctly received), the mobile terminal 10 simply remains under control of the serving BTS 18, and the network 50 knows from the lack of a confirmation message from the mobile terminal 10 that the handover did not take place as expected.

In one embodiment, the network 50 determines which BTSs can be considered for a handover, provides advance information of the shared control channels of those other candidate BTSs to the mobile terminal 10, and may provide information to the mobile terminal 10 that is descriptive of an expected delay from the uplink signaling message (e.g., the measurement message sent from the mobile terminal 10) for the time when to expect shared control channel signaling for the terminal 10. For example, the mobile terminal 10 sends the measurement message in uplink direction, and 200 ms after that transmission the target BTS 20 might send data over its shared control channel 28 to the mobile terminal 10 within a 10 ms window. Different BTSs may have different timing values, but a single set of values is preferred (e.g., 200 ms and 10 ms as in the example above). A consideration of such timing-related information can be found in R2-050965 (3GPP TSG-RAN1 Meeting #40bis, Apr. 4-8, 2005, Beijing, China, Qualcomm).

A more simplified embodiment finds the mobile station 10 discontinuing monitoring of the shared data channel 22 of the serving BTS 18 when checking for reception of the shared control channel 28 of the target BTS 20 during the handover window 44, as the automatic repeat request (ARQ, preferably hybrid-ARQ) will take care of any required re-transmissions.

The mobile terminal 10 may initiate a measurement report in the uplink direction that indicates a change of the best serving HS-DSCH cell measurement report for HSDPA, the change being from a serving cell 18 to a target cell 20. The terminal 10 then listens to a high speed shared control channel HS-SCCH of the target cell 20 during at least one predefined time instant (e.g., some instant within the handover window 44), where the time instant is relative to the measurement report sent in the uplink direction. During the change from serving 18 to target 20 cell, the terminal 10 does not need to listen to a HS-SCCH of both the serving cell 18 and of the target cell 20 at any given time. The time instant being relative to the measurement report may be, for example, the network (e.g., RNC 52) determining the window 44 during which the terminal 10 monitors the HS-SCCH of the target cell 20 based on a time offset from when the measurement report was sent. The serving cell 18 is also informed of the predefined time instant (e.g., if the RNC determines the instant or window 44), which the serving cell 18 recognizes as a time that the terminal 10 may ignore transmissions from that serving cell 18, since the terminal 10 will be anticipated to monitor the HS-SCCH of the target cell 20 at that time instant. The target cell 20 may also be informed of the predefined time instant or window 44 when the terminal 10 is expected to listen to the HS-SCCH of the target cell 20. The target cell 20 is preferably identified in the original “change of the best serving HS-DSCH cell measurement report” sent from the terminal.

As a further enhancement to the teachings of this invention, the mobile control channels that are received from two or more neighboring BTSs. This mode of operation permits the network 50 to have more than one handover candidate BTS at a time. The number of shared control channels that can be received by the mobile terminal 10 is dependent at least in part on the allowed buffering delay of VoIP packets: the more delay that is allowed, the more occasions there will be to receive the information from the various shared control channels of the neighboring BTSs.

FIG. 3 is a signaling flow diagram between the mobile terminal 10 and network 50 elements, specifically the serving BTS 18, the target BTS 20 and the RNC 52. Initially, the mobile terminal 10 sends a measurement message 54 to the network, shown as sent to the RNC 52 but that message 54 may be relayed through the serving BTS 18. At that time, the mobile terminal 10 monitors the downlink shared data channel 56 from the serving BTS 18 no handover has been initiated by the network 50. Once the network 50 (RNC 52 as shown) determines that a handover is appropriate, the RNC 52 sends the information about the shared control channel 28 of the target BTS 20 in a “HS-SCCH INFORMATION” message 58, and that message 58 also includes the handover window defined within an interval 30.

Upon reception of that message 58, the mobile terminal 10 monitors 60 the shared control channel 28 of the target BTS 20 during the handover window 44, and at some point in time, during a handover window 44 in one of the intervals 30, the target BTS 20 sends a message directed to the mobile terminal 10 over the target BTS's shared control channel 28. As above, in some implementations that message directed to the mobile terminal 10 is merely the mobile terminal's identity, but may include information about the target BTS's shared data channel 26 if that information was not provided in the “HS-SCCH INFORMATION” message 58. Data such as VoIP packets are then provided to the mobile terminal 10 over that data channel 26, which the mobile terminal monitors following receipt of its identity over the shared control channel 28. Predicate on the mobile terminal receiving (either or both of) its identity over the shared control channel 28 or the shared data channel 26 of the target BTS 20, the mobile terminal 10 then sends a confirmation message 66 to the network 50 (the RNC 52 as shown), and discontinues 68 monitoring the shared control channel 24 of the serving BTS 18. At that point, handover is complete and the target BTS 20 becomes the serving BTS 18.

Note in FIG. 3 that the confirmation message 66 from the mobile terminal 10, indicating of completion of a successful handover process, is shown as being conveyed by a Radio Bearer (RB) Reconfiguration Complete message. This particular message format is defined in 3GPP TS 25.331, although in other embodiments a different message could be used or defined for this purpose. Alternatively, to speed LIP the handover process, an indication of completion of successful handover to RNC could be generated by the target BTS 20 instead of the mobile terminal 10, after the target BTS 20 has established a connection with the mobile terminal 10 on the shared data channel 26 of the target BTS 20. In this case, the mobile terminal 10 stops receiving the shared control channel 24 of the serving BTS 18 immediately after it has successfully decoded data over the shared data channel 26 of the target BTS 20. The target BTS 20 may confirm that communications are established over the shared data channel 26 with the mobile terminal 10 by any number of means, including receiving an acknowledgement message from the mobile terminal on an uplink channel, or failing to receive an ARQ message from the mobile terminal 10 (each within a specified period of time following the data packet 40 sent from the target BTS 20 over its shared data channel 26).

Note further that FIG. 3 is simplified, as it does not show the message flow between the RNC 52 and the BTSs 18, 20. Further, it should be noted that in practice certain of the messages may preferably terminate at the serving BTS 18 and/or the target BTS 20 to eliminate the additional delay when either of those BTSs forwards a message on to the RNC 52.

It should be appreciated that, based on the foregoing description, one significant advantage that is gained by the use of the embodiments of this invention is that no additional HSDPA terminal 10 receiver capabilities are needed for achieving a fast HS-DSCH serving cell handover.

Further, as the handover frequency is on the order of seconds rather than milliseconds, any impact of the additional timing considerations on the mobile terminal 10 and the serving/target BTSs 18, 20 is minimal.

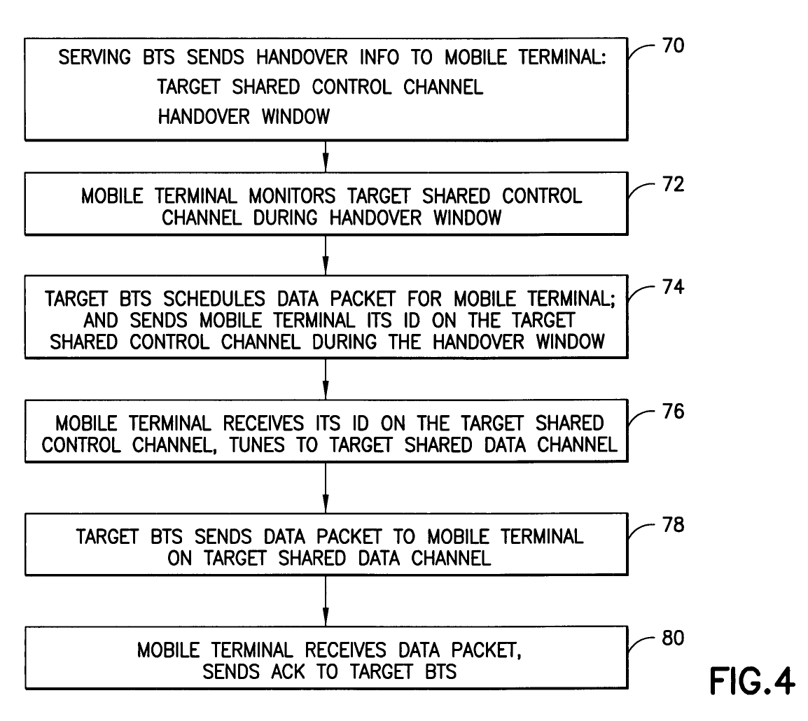

FIG. 4 illustrates process steps used in implementing an embodiment of the invention. At block 70, the serving BTS 18 sends to the mobile terminal 10 information about the pending handover, preferably the shared control channel of the target BTS 20 and the handover window during which the mobile terminal 10 should monitor that shared control channel during each time interval. The various network elements and the mobile terminal 10 know in advance the fixed time interval set by the network, and any disparities in clocks between the serving BTS 18 and the target BTS 20 may be resolved by the RNC 52 by an offset to one of them as to the handover window start point. The RNC 52 ensures that both the serving BTS 18 and the target BTS 20 know the handover window.

At block 72, the mobile terminal 10 then monitors the shared control channel of the target BTS 20 during the handover window, using the information it received in the message from block 70. Eventually, the target BTS 20 receives a data packet destined for the mobile terminal, and schedules it for transmission at block 74. Prior to sending the data packet, the target BTS sends the mobile terminal ID over the target BTS's shared control channel during the handover window.

The mobile terminal 10, which has already begun monitoring the shared control channel of the target BTS 20 during the handover window in each of the fixed time intervals 30 set by the network 50, recognizes at block 76 its identifier of the shared control channel of the target BTS 20, which it recognizes as an indicator that data has been scheduled for it on the shared data channel of the target BTS 20. The mobile terminal 10 then tunes to the shared data channel of the target BTS 20.

At block 76, the target BTS 20 sends the data packet to the mobile terminal 10, most preferably within the same time interval 30 as it sent at block 74 the mobile terminal's ID on the shared control channel. The mobile terminal 10, having already tuned to the target BTS's shared data channel once it received its ID on the shared control channel, then receives the data packet from the target BTS 20 and sends an acknowledgement, which may be as simple as an ACK message or which may be a “reconfiguration complete” message as detailed above. The mobile terminal then is fully handed over to the target BTS 20 and no longer need monitor any channel from the serving BTS 18.

Based on the foregoing description of non-limiting embodiments of this invention it can be appreciated that an aspect of this invention relates to apparatus, methods and a computer program for operating the mobile terminal 10 to perform a handover from a serving cell to a target cell by receiving a message that includes information needed to receive a shared control channel from the target cell, to listen to the shared control channel of the target cell for a predetermined period of time to determine if an identification of the mobile terminal 10 is received from the target cell and, upon receiving the identification, to send a confirmation of the handover being successful and to begin receiving data packets from a shared data channel of the target cell.

Based on the foregoing description of non-limiting embodiments of this invention it can be further appreciated that an aspect of this invention relates to apparatus, methods and a computer program for operating a network element to perform a handover of the mobile terminal 10 from a serving cell to a target cell by sending a message to the mobile terminal 10 that includes information needed to receive a shared control channel from the target cell, to schedule a next packet transmission to the mobile terminal 10 from the target cell and to send an identification of the mobile terminal 10 from the target cell and, upon receiving a confirmation from the mobile terminal 10 of the handover being successful, to send data packets to the mobile terminal 10 over a shared data channel of the target cell.

In general, the various embodiments of the mobile terminal 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The mobile terminal 10 also contains a wireless section that includes a digital signal processor (DSP) that may be within the illustrated DP 14 or a separate processor, or equivalent high speed processor or logic, as well as a wireless transceiver 12 that includes a transmitter and a receiver, both of which are coupled to an antenna for communication with the network serving and target nodes. At least one local oscillator, such as a frequency synthesizer, is provided for tuning the transceiver. Data, such as digitized voice and packet data, is transmitted and received through the antenna. The wireless section maybe considered to function as a long-range interface (e.g., hundreds or thousands of meters) to the target and serving nodes or base stations which are a part of the network 50. Note that the mobile terminal 10 may also include a local area wireless transceiver, such as one based on Bluetooth™ low power RF or infrared (IR) technology. Such a local area transceiver may be considered as a short range interface (e.g., meters or tens of meters) for coupling to a wireless local area network (WLAN) via a suitable access point, but such a local transceiver is considered incapable of communicating with the UTRAN network 50 due to range and power requirements for the network.

The data processor 14 is coupled to some type of a memory 16, including a non-volatile memory for storing an operating program and other information, as well as a volatile memory for temporarily storing required data, scratchpad memory, received packet data, packet data to be transmitted, and the like. The operating program is assumed, for the purposes of this invention, to enable the DP 14 to execute the software routines, layers and protocols required to implement the methods and functions in accordance with the exemplary embodiments of this invention. Although not shown, a microphone and speaker are typically provided for enabling the user to conduct voice calls in a conventional manner.

The exemplary embodiments of this invention may be implemented by computer software executable by the data processor 14 of the mobile terminal 10 or by a data processor within the network nodes 18, 20. Execution may be by a combination of software and hardware.

The memory 16 may be of any type suitable to the local technical environment and may be implemented using any suitable data storage technology, such as semiconductor-based memory devices, magnetic memory devices and systems, optical memory devices and systems, fixed memory and removable memory. The data processor(s) 14 may be of any type suitable to the local technical environment, and may include one or more of general purpose computers, special purpose computers, microprocessors, digital signal processors (DSPs) and processors based on a multi-core processor architecture, as non-limiting examples.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but one example, the use of other similar or equivalent message types and/or timing parameters may be attempted by those skilled in the art. However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and embodiments of this invention, and not in limitation thereof.

What is claimed is:

1. A wireless communication system comprising a serving cell and a target cell for handing over a mobile terminal, wherein:
the serving cell comprises a processor, a memory for storing a first set of instructions, a transceiver and an antenna that are together configured to wirelessly send a message to the mobile terminal that includes information needed to receive a shared control channel of the target cell; and
the target cell comprises a processor, a memory for storing a second set of instructions, a transceiver and an antenna that are together configured to schedule a data packet for transmission to the mobile terminal, to wirelessly send an identification of the mobile terminal over the shared control channel at a time defined by the information, and to wirelessly send the data packet to the mobile terminal over a shared data channel.

2. The wireless communication system of claim 1, wherein the target cell is further configured to schedule and send additional packets to the mobile terminal over the shared data channel upon receiving a confirmation that a handover of the mobile terminal to the target cell is successful.

3. A method comprising:
receiving, over a first shared channel from a serving base transceiver station, channel information about a second shared channel of a target base transceiver station and a handover window;
using the received channel information, monitoring the second shared channel during the handover window of each of at least two fixed time intervals.

4. The method of claim 2, wherein the first shared channel comprises a downlink shared data channel and the second shared channel comprises a downlink shared control channel.

5. The method of claim 3, further comprising:
during the handover window in one of the time intervals, receiving over the second shared channel a control message comprising an identity of a mobile terminal that was monitoring the second shared channel during the handover window; and
sending from the mobile terminal a handover confirmation message.

6. The method of claim 5, further comprising:
discontinuing monitoring of the first shared channel after receiving the control message over the second shared channel.

7. The method of claim 3, wherein a mobile terminal executing the method monitors at any given time only one of the first shared channel and the second shared channel.

8. The method of claim 3, wherein monitoring the second shared channel during the handover window in each of at least two fixed time intervals comprises monitoring the second shared channel during the handover window in every time interval until at least one of:
a specified time elapses without reception over the second shared channel of a control message directed to a mobile terminal monitoring the second shared channel; or
receipt of a message on either the first shared channel or on another shared channel of the serving base transceiver station to discontinue monitoring the second shared channel during the handover window.

9. A mobile terminal comprising:
a transceiver;
a processor coupled to the transceiver; and
a memory coupled to the processor for storing a set of instructions, executable by the processor, for determining from a first message received at the transceiver over a first channel a second channel to monitor and a handover window during which to monitor, and for tuning the transceiver to monitor the second channel during the handover window in each of at least two fixed time intervals.

10. The mobile terminal of claim 9, wherein the instructions are further for, responsive to receiving over the second shared channel a control message with an identity of the mobile terminal, causing the transceiver to send a confirmation message.

11. The mobile terminal of claim 10, wherein the instructions further cause the transmitter to discontinue monitoring of the first shared channel following sending of the confirmation message.

12. A program of machine-readable instructions, tangibly embodied on an information bearing medium and executable by a digital data processor, to perform actions directed toward handing over a mobile terminal between network elements, the actions comprising:
determining from a message, wirelessly received over a first shared channel from a serving base transceiver station, channel information about a second shared channel of a target base transceiver station and a handover window;
using the received channel information, configuring a transceiver to monitor the second shared channel during the handover window of each of at least two fixed time intervals.

13. The program of claim 12, wherein the actions further comprise:
configuring a transceiver to send a confirmation message, automatically in response to receiving over the second shared channel a control message directed to the host device of the program.

14. The program of claim 12, wherein the actions further comprise:
discontinuing configuration of the transceiver to monitor the first shared channel, automatically following the sending of the confirmation message.

15. A method comprising:
transmitting, from a serving base transceiver station to a mobile terminal over a first shared channel, channel information about a second shared channel of a target base transceiver station and a handover window; and
restricting all transmissions from the serving base transceiver station to the mobile terminal so as to avoid the handover window of each of at least two fixed time intervals subsequent to the transmitting.

16. The method of claim 15, wherein restricting all transmissions from the serving base transceiver station continues in all time intervals subsequent to the transmitting until one of:
receiving a message that a handover of the mobile terminal to the target base transceiver station has not been effected; or
a specified time elapses without reception of a confirmation message that originated from the mobile terminal confirming handover to the target base transceiver station.

17. The method of claim 15, wherein the first shared channel comprises a shared data channel shared among a plurality of mobile terminals.

18. A network element comprising:
a transceiver;
a processor coupled to the transceiver; and
a memory coupled to the processor for storing a set of instructions, executable by the processor, for:
compiling a first message comprising information about a second channel and a handover window during which to monitor the second channel;
configuring the transceiver to send the first message over a first channel to a mobile terminal; and
restricting transmissions from the network element to the mobile terminal so as to avoid the handover window in each of at least two fixed intervals subsequent to sending the first message.

19. The network element of claim 18, wherein restricting transmissions from the network element continues in all time intervals subsequent to the sending until one of:
the transceiver receives a second message that a handover of the mobile terminal to another network element has not been effected; or
a specified time elapses without reception at the transceiver of a confirmation message that originated from the mobile terminal confirming handover to another network element.

20. A program of machine-readable instructions, tangibly embodied on an information bearing medium and executable by a digital data processor, to perform actions directed toward handing over a mobile terminal between network elements, the actions comprising:
transmitting, from a serving base transceiver station to a mobile terminal over a first shared channel, channel information about a second shared channel of a target base transceiver station and a handover window; and
restricting all transmissions from the serving base transceiver station to the mobile terminal so as to avoid the handover window of at least two fixed time intervals subsequent to the transmitting.

21. The program of claim 20, wherein restricting all transmissions from the serving base transceiver station continues in all time intervals subsequent to the transmitting until one of:
receipt of a message that a handover of the mobile terminal to the target base transceiver station has not occurred; or
a specified time elapses without reception of a confirmation message that originated from the mobile terminal confirming handover to the target base transceiver station has occurred.

22. A method for operating a network element comprising:
during a predefined handover window, sending over a shared control channel a transmission directed to an individual mobile terminal that is not under the control of a network element sending the transmission;
following sending over the shared control channel, sending over a shared data channel a transmission directed to the individual mobile terminal;
confirming that communication with the mobile terminal over the shared data channel is established; and
responsive to confirming that communications with the mobile terminal is established, sending a handover confirmation message to a radio network controller.

23. A method for downlink packet data transmission within UTRAN using HSDPA, comprising:
initiating at a terminal a measurement report in the uplink direction that indicates a change of a best cell from a serving cell to a target cell for high-speed data packet access HSDPA;
listening at the terminal to a high speed shared control channel HS-SCCH of the target cell during at least one predefined time instant, where the time instant is relative to the measurement report sent in the uplink direction;
wherein the terminal does not need to listen to a HS-SCCH of both the serving cell and of the target cell at any given time during the change to the target cell.

24. The method of claim 23, further comprising,
informing the serving cell of the at least one predefined time instant when the terminal may ignore transmissions from the serving cell.

25. The method of claim 23, further comprising,
informing the target cell, indicated in the measurement report from the terminal, of the at least one predefined time instant when the terminal is expected to listen to at least the HS-SCCH of the target cell.
